(19) United States
(12) Patent Application Publication
(10) Pub. No.: US 2014/0079270 A1
(43) Pub. Date: Mar. 20, 2014

(54) EAR APPLIANCE

(71) Applicant: SENNHEISER COMMUNICATIONS A/S, Solrod Strand (DK)

(72) Inventors: Mohamad ESSABAR, Solrod Strand (DK); Peter Vestergård VÆRUM, Solrod Strand (DK); Johannes Sejr KAULFUSS, Solrod Strand (DK); Peder Hesselbjerg PEDERSEN, Solrod Strand (DK)

(73) Assignee: SENNHEISER COMMUNICATIONS A/S, Solrod Strand (DK)

(21) Appl. No.: 14/028,062

(22) Filed: Sep. 16, 2013

Related U.S. Application Data
(60) Provisional application No. 61/701,741, filed on Sep. 17, 2012.

(30) Foreign Application Priority Data
Sep. 17, 2012 (EP) 12184664.6

(51) Int. Cl. H04R 1/10

(52) U.S. Cl. CPC H04R 1/1091
USPC 381/370

(57) ABSTRACT

An ear appliance is provided which comprises a headphone having a cup which is coupled to soft padding, and a protector which is adapted to cover the soft padding and at least a part of the cup. The protector comprise at least one material layer with a compound in said layer having a phase change ability said compound being adapted to change phase at a predetermined temperature range.

### AREA OF THE INVENTION

The invention regards an ear appliance which abuts the outer ear or the head around the outer ear, and feeds sound into the ear, and/or blocks outside noise from reaching the ear. In case the element also comprise a microphone for capturing the users voice, it may be termed a headset. The ear appliance thus comprises ear cups or ear muffs which are customarily used for such devices. When worn for a longer duration, heat may build up between the users head and the ear cup, which causes dis-comfort for the user.

### BACKGROUND OF THE INVENTION

It has been suggested to add cool keeping materials such as spheres of phase change element to the composition of the ear or head abutting ear cup, but this turns out to have a serious down side in the form of reduced comfort, as the head or ear abutting materials will tend to become rather stiff and will thus lack the ability to adjust to the individual shape of the users head and ear. Further, once the phase change materials have all reached an elevated temperature, the heating build up will continue and the user is left without any remedy at that time.

From US application No 20050089185 an ear seal is known for use in a headset, said ear seal comprising an inner annular surface for contacting a headset and an outer annular surface for contacting a user's head, said ear seal further including a flexible foam matrix material proximate said outer annular surface, and said flexible foam matrix material containing a thermal storage material capable of storing thermal energy as latent heat of phase change.

The object of the invention is to provide an ear appliance which is more comfortable, and which will prevent build up of heat, and which allows continuous use of the ear appliance.

### SUMMARY OF THE INVENTION

An ear appliance is provided, which comprises a headphone having a cup which is coupled to soft padding, and a protector which is adapted to cover the soft padding and at least a part of the cup wherein the protector comprise at least one material layer with a compound in said layer having a phase change ability said compound being adapted to change phase at a predetermined temperature range. The compound in the material layer will absorb heat when the temperature in it rises above the value for its phase change, and during phase change of all of the compound, the temperature will stay constant, and the heat will be absorbed in the now liquid compound. By having the phase change material in a specific material layer, the effect may be provided where it is most needed, such as close to the skin surface of a wearer of a headset. Further, the pliability and softness of such layers may be maintained, which ensures better comfort for the user, even if some loss of comfort must be accepted in order to achieve a cool keeping effect.

The phase change temperature of the compound may be chosen to lie in the range of 25 to 30 degrees Centigrade, and this temperature range is the range of skin surface temperatures in which most people would find the presence of a headset pressed against the ear or ear surroundings to be not thermally distressing. The temperature may be managed by choice of compound or mixture of different compounds.

The material layer comprising the phase change material may be provided externally of the soft padding of the ear cup. In this way the material will be interposed between the skin and the padding when the ear cup is placed on the ear. The construction ensures that all of the phase change material is placed in close vicinity of the skin of a user.

The external material layer and the internal material layer may be joined at an inner substantially circular rim. The rim may form the outline of a hole, or the one or both material layers may extend across the area defined by the inner circular rim. If the rim defines a hole, sound may pass through this hole and reach the ear without being impediment from the material layers.

The material layers may be joined at an outer rim having a diameter adapted to match the diameter of the headphone. This facilitates the formation of an enclosure for the material layers carrying the phase change material, and ensures that these layers are correctly placed between the soft padding and the skin of the user when the ear cup with the protector is warn.

The phase change material layers may be provided in a thoroidal area with a hole in the middle, such as the area defined by the inner and the outer rim provided by the joining of the two material layers.

The phase change material may be embedded in a woven or felted material layer, preferably in the form of microspheres where each sphere is surrounded by a polymer layer. Such a material layer may remain a degree of flexibility regardless of the phase condition of the phase change material, and this is an important advantage, as the user will find the device more comfortable when the material layers are flexible.

At least on material layer may be provided, and preferably 3 material layers are provided, and this will ensure better comfort. The individual layers may have a thickness of no more than 1.0 mm or no more than 0.5 mm or no more than 0.4 mm. Individual layers of no more than 0.4 mm thickness will remain flexible irrespective of the state of the phase change material inside the spheres, and

The invention also regards an exchangeable protector. The protector comprises a bowl of flexible material having a bottom, a cylindrical side, a mouth terminating the cylindrical side and further a phase change material is provided mainly at the bottom, which is adapted to abut the soft padding of a headphone when the exchangeable protector is stretched over a headphone.

The invention further regards a method for obtaining a substantially un-changed temperature in the skin abutting surface of a headphone during prolonged use, whereby a protector as defined above in a first step is stored at or below ambient temperature allowing the phase change material to solidify, an whereby the protector in a second step is attached to the headphone, the headphone is used in a third step causing the phase change material situated close to the skin to change phase and become liquid while heat from the users skin is absorbed, and when liquid state of substantially all the phase change material at the skin has been reached, the protector is removed in a forth step from the headphone and returned to a cooler environment for delivery of heat to this environment and re-solidification of the phase change material.

The method may further comprise use of two protectors such that the one protector is attached to the headphone while the other is stored in the cooler environment, such that the user may exchange the one with the other at intervals and always maintain a low temperature of the headphone.

It is intended that the structural features of the protector and ear cup system described above, in the detailed description and in the claims can be combined with the method, when appropriately substituted by a corresponding process. Embodiments of the method have the same advantages as the corresponding systems.

Further objects of the invention are achieved by the embodiments defined in the dependent claims and in the detailed description of the invention.

As used herein, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present, unless expressly stated otherwise. Furthermore, “connected” or “coupled” as used herein may include wirelessly connected or coupled. As used herein, the term “and/or” includes any and all combinations of one or more of the associated listed items. The steps of any method disclosed herein do not have to be performed in the exact order disclosed, unless expressly stated otherwise.

### BRIEF DESCRIPTION OF THE DRAWINGS

FIG. 1 shows a sectional view of a headphone with a protector mounted thereon,

FIG. 2 shows a sectional view through a part of an ear appliance, and the skin of the user.

Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DESCRIPTION OF A PREFERRED EMBODIMENT

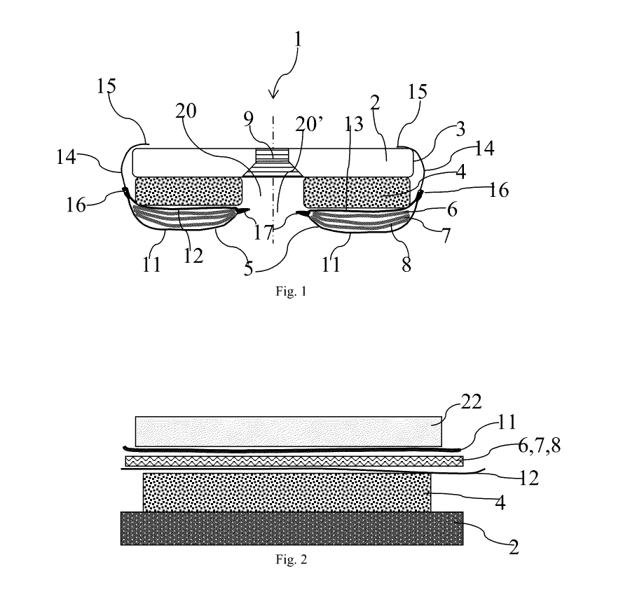

An ear appliance is shown in FIG. 1. The appliance comprises a headphone 1 having an ear cup 2 which is coupled to soft padding 4, and a removable protector 5 which is adapted to cover the soft padding and at least a part of the ear cup 2. The exchangeable protector 5 comprise at least one material layer 6,7,8 with a compound having a phase change ability from fluid to solid state said compound being adapted to change phase at a predetermined temperature range. The temperature range is chosen to match the usual temperature of skin 22 of ear and ear surroundings of a typical user of a headset.

Centrally placed in the cup 2 a speaker 9 may be provided, such that sounds may be propagated to the ear from the speaker 9. The soft padding 4 is provided as a torus with a centrally arranged hole 20 allowing sounds from the speaker 9 to pass to the ear. The soft padding 4 comprises an outer layer such as leather, tissue, foil or the like which surrounds a soft fill material. As is known in the art, the padding 4 may alternatively comprise a foamed body or the like with no separate outer layer. The padding element is attached to the cup 2 in a manner well known in the art such as by a permanent connection or by a connection allowing it to be replaced.

As seen in FIG. 1 the phase change material is provided mainly in areas of the exchangeable protector 5 which corresponds to the areas where the soft padding 4 of the ear cup 2 is adapted to be pressed towards the skin 22 of a wearer when the exchangeable protector 5 is mounted on the headphone 1. The ear appliance may be worn at the ear without the removable protector 5 or with it according to the users liking. When no protector is provided the surface part of the padding further away from the cup 2 will be pressed against the users ear, and when the exchangeable protector 5 is mounted at the cup 2 the phase change layers 6, 7, 8 will be interposed between the skin 22 and the padding element 4 and the phase change layers will thus be gently pressed towards the users ear and/or skin 22 surrounding the ear.

The phase change material layers 6,7,8 may be provided in a thoroidal area with a hole 20′ in the middle. This will facilitate transmission of sounds from the speaker to the ear. The phase change layers are disposed between an inner protector material layer 11 and an outer protector material layer 12. As seen in FIG. 1 these protector material layers 11, 12 are left out in the area of the hole 20′. The layers 11,12 may however be left covering the hole 20′ in case they are sufficiently transparent to the sound signal from the loudspeaker.

The inner protector material layer 11 should preferably have high heat transmission ability, such that heat may flow from the user's skin 22, through the layer 11 to be absorbed by the phase change material. When the phase change material in the layers 6, 7, 8 has reached the phase change temperature, the phase change process will provide a constant temperature in the material and no significant rise in temperature will take place. The high heat transmission ability of the inner protector material layer 11 may be achieved by the composition of the material, by the thickness thereof or by air permeability thereof or by combinations of these effects.

The exchangeable protector 5 as disclosed in FIG. 1 comprises a bowl of material having a bottom 13, a cylindrical side 14, a mouth 15 which terminates the cylindrical side 14. A phase change material is further provided mainly at the bottom 13. The bowl is made of a flexible material such as cloth being woven, knitted, felted, molded or generated in some other process which is suited to make sheet like flexible materials. The bottom 13 is adapted to abut the soft padding 4 of a headphone 1 when the replaceable protector 5 is stretched over the headphone.

The outer material layer 12 and the inner material layer 11 at the bottom 13 are joined at an outer rim 16. This rim has a diameter which is adapted to match the diameter of the headphone 1. The joining of the two material layers may be accomplished in a number of different ways, including gluing, welding, sewing or the like. The material layers may well be rather flexible and have some elasticity property, and the matching of the diameter of rim 16 with the diameter of the headphone need thus not be exact, and depending on the elasticity of the materials used, the rim may well fit or match headphones of different sizes. The outer and inner layers may be made from the same material or have different material properties.

As further seen in FIG. 1 the outer material layer 12 and the inner material layer 11 are also joined at an inner rim 17 defining a sound opening 20′. This opening is aligned axially with the opening 20 from which sound will be emitted when the speaker 9 is active. This inner rim 17 may also be generated in a well known way such as by gluing, sewing, welding or the like.

The cylindrical skirt portion 14 is joined to the outer rim 16 and as seen the skirt portion 14 has a diameter which matches the diameter of the headphones 2. Again the matching need not be precise as elasticity of the materials used will allow for some degree of slack without compromising the function of the protector 5.

A mouth part 15 is made with decreasing diameter and the flexible material may be stretched over the ear cup 2 and thus ensure attachment of the protector 5 to the ear cup 2.

The phase change material is embedded in a woven or felted material layer, preferably in the form of microspheres each sphere surrounded by a polymer layer. The polymer layer ensured that the phase change material remains in place and does not flow away when it is in its fluid state. The material layers may also comprise foamed or cast materials, or layers generated in other ways which allows the microspheres of phase change materials to be embedded therein.

It is required that at least one material layer is provided, and in the shown embodiment 3 material layers 6,7, 8 are provided. More layers may be used for more coolkeeping effect, however this will add to both weight and size and give the protection element a more stiff and less comfortable feel. Suitable material layers are obtainable commercially and 3 layers may be used as this will be a reasonable compromise between comfort and cool keeping effect. The use of more and thinner layers will add to the comfort of the ear cup as the individual layers will have more flexibility than will a single thicker layer with the same heat capacity.

Each material layer may have a heat storage capacity of 11200 J/m² resulting from phase change from solid to fluid phase of the embedded phase change material.

1. Ear appliance comprising a headphone having a cup which is coupled to soft padding, and a protector which is adapted to cover the soft padding and at least a part of the cup wherein the protector comprise at least one material layer with a compound in said layer having a phase change ability from fluid to solid state said compound being adapted to change phase at a predetermined temperature range.

2. Ear appliance as claimed in claim 1, wherein the temperature range is within the boundaries of 25 to 30 deg. Celsius.

3. Ear appliance as claimed in claim 1, wherein the phase change material is provided mainly in areas of the protector which corresponds to the areas where the soft padding of the ear cup is adapted to press towards the skin of a wearer.

4. Ear appliance as claimed in claim 2, wherein an external material layer adapted to abut the skin of a user is provided, and that the phase change material layer in the protector is provided adjacent to this material layer.

5. Ear appliance as claimed in claim 4 wherein an internal material layer adapted to abut the soft padding of the ear cup is provided.

6. Ear appliance as claimed in claim 5 wherein the external material layer and the internal material layer are joined at an inner substantially circular rim.

7. Ear appliance as claimed in claim 6, wherein the external material layer and the internal material layer are joined at an outer rim having a diameter adapted to match the diameter of the headphone.

8. Ear appliance as claimed in claim 7 wherein a cylindrical skirt is joined to the outer rim, said skirt having a mouth with a reduced diameter.

9. Ear appliance as claimed in claim 3, wherein the phase change material layers are provided in a thoroidal area with a hole in the middle thereof.

10. Ear appliance as claimed in claim 6, wherein the inner and/or the outer protector material layer is left out in the area of the hole.

11. Ear appliance as claimed in claim 3, wherein the phase change material is embedded in a woven or felted material layer, preferably in the form of microspheres where each sphere is surrounded by a polymer layer.

12. Ear appliance as claimed in claim 9, wherein at least on material layer with embedded phase change material therein is provided, and preferably 3 material layers are provided.

13. Exchangeable protector comprising a bowl of flexible material having a bottom, a cylindrical skirt, a mouth terminating the cylindrical skirt and wherein a phase change material is provided at the bottom, which is adapted to abut soft padding of a headphone when the exchangeable protector is stretched over a headphone.

14. Protector as claimed in claim 13, wherein the phase change material has a phase change temperature going from solid to fluid phase of no less than 25 and no more than 30 deg. Celsius.

15. Protector as claimed in claim 13, wherein the phase change material is provided between an external material layer adapted to abut the skin of a user, and an internal material layer adapted to abut the soft parts of a headphone.

16. Protector as claimed in claim 15, wherein the external material layer and the internal material layer are joined at an outer rim having a diameter adapted to match the diameter of the headphone.

17. Protector as claimed in claim 15, wherein the external material layer and the internal material layer are joined at an inner rim defining a sound opening.

18. Protector as claimed in claim 16, wherein the cylindrical skirt is joined to the outer rim, this skirt portion having a diameter which matches the diameter of the headphones.

19. Protector as claimed in 17, wherein the skirt portion comprises a mouth part, which has a decreased diameter, such that this mouth part may be stretched over an ear cup of a headphone for attachment to a headphone.

20. Protector as claimed in claim 13, wherein the phase change material is embedded in a woven or felted material layer, preferably in the form of microspheres each sphere being surrounded by a polymer layer.

21. Protector as claimed in claim 20, wherein at least one material layer is provided, and preferably 3 material layers are provided.

22. Protector as claimed in claim 21, wherein each material layer has a heat storage capacity of 11200 J/m² resulting from phase change from solid to fluid phase of the embedded phase change material.

23. Method for obtaining a substantially un-changed temperature in the skin abutting surface of a headphone during prolonged use, whereby a protector as claimed in claim 13 in a first step is stored at or below ambient temperature allowing the phase change material to solidify, an whereby the protector in a second step is attached to the headphone, the headphone is used in a third step causing the phase change material situated close to the skin to change phase and become liquid while heat from the users skin is absorbed, and when liquid state of substantially all the phase change material at the skin has been reached, the protector is removed in a forth step from the headphone and returned to a cooler environment for delivery of heat to this environment and re-solidification of the phase change material.

24. Method as claimed in claim 23, wherein two protectors are used such that the one protector is attached to the headphone while the other is stored in the cooler environment, such that the user may exchange the one with the other at intervals and always maintain a low temperature of the headphone.
